(19) United States
(12) Patent Application Publication
(10) Pub. No.: US 2007/0220034 A1
(43) Pub. Date: Sep. 20, 2007

(54) Automatic training of data mining models

(75) Inventors: Raman S. Iyer, Redmond, WA (US); C. James MacLennan, Redmond, WA (US); Ioan Bogdan Crivat, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/377,024

(22) Filed: Mar. 16, 2006

(51) Int. Cl. G06F 7/00

(52) U.S. Cl. 707/102

(57) ABSTRACT

A realtime training model update architecture for data mining models. The architecture facilitates automatic update processes with respect to evolving source/training data. Additionally, model update training can be performed at times other than in realtime. Scheduling can be invoked, for periodic and incremental updates, and refresh intervals applied through the training parameters for the mining structure and/or model. Training can also be triggered by user-defined events such as database notifications, and/or alerts from other operational systems. In support thereof, a data mining model component is provided for training a data mining model on a dataset in realtime, and an update component for incrementally training the data mining model according to predetermined criteria. Additionally, model versioning and version comparison can be employed to detect significant changes and retain updated models. Training data aging/weighting of training data can be applied.

### BACKGROUND

More data is being received, processed, analyzed, and stored than ever before. This is because businesses recognize the importance of this data for use in analyzing consumer spending behaviors, trends, and other information patterns which allow for increased sales, customer profiling, better service, risk analysis, and so on. However, due to the enormity of the information, mechanisms such as data mining have been devised that extract and analyze subsets of data from different perspectives in attempt to summarize the data into useful information.

One function of data mining is the creation of a model. Models can be descriptive, in that they help in understanding underlying processes or behavior, and predictive, for predicting an unforeseen value from other known values. Using a combination of machine learning, statistical analysis, modeling techniques and database technology, data mining finds patterns and subtle relationships in data and infers rules that allow the prediction of future results.

The process of data mining generally consists of the initial exploration, model building or pattern identification and deployment (the application of the model to new data in order to generate predictions). Exploration can start with data preparation which may involve cleaning data, data transformations, selecting subsets of records. Model building and validation can involve considering various models and choosing the best one based on their predictive performance, for example. This can involve an elaborate process of competitive evaluation of the models to find the best performer. Deployment involves applying the selected model to new data in order to generate predictions or estimates of the expected outcome.

Mining models are trained to ensure viability over the changing patterns in data. However, such mining models can quickly become outdated if not periodically updated to reflect changes in the behavior of the entities being modeled.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed innovation allows for automatically keeping mining models up-to-date with respect to evolving source/training data. A typical scenario is where the user wants the model to be based on a moving window of data, for instance, the last three months of purchases.

Systems are disclosed in support of update training for models at times other than in realtime. Accordingly, periodic, incremental updates can be scheduled through this mechanism as well. The user can configure a refresh interval and other associated values through the training parameters for the mining structure and/or model. Training can also be triggered by other user-defined events such as database notifications, and/or alerts from other operational systems. Once the mining structure and its contained models are initially processed, they are automatically reprocessed by the data mining engine.

The invention disclosed and claimed herein, in one aspect thereof, comprises a computer-implemented system for training of a data mining model. The system can include a data mining model component for training a data mining model on a dataset in realtime, and an update component for updating the data mining model according to predetermined criteria.

In another aspect thereof, the user can specify automatic model training information using a mining model definition language, in both XML DDL (data definition language) (analysis service scripting language) and query language enhancements in the DMX language (Data Mining eXtensions to the SQL language).

In another aspect, the invention functions in conjunction with model versioning and version comparison to detect significant changes and retain updated models only if a threshold criterion is met.

In yet another aspect, the system utilizes a data mining engine and algorithm enhancements including incremental training and aging/weighting of training data (e.g., older data can be retained, but assigned less weight during the learning process).

Additionally, enabled are scenarios not addressed by existing products such as product differentiation for SQL Server Data Mining in the data mining market.

In still another aspect thereof, a machine learning and reasoning component is provided that employs a probabilistic and/or statistical-based analysis to prognose or infer an action that a user desires to be automatically performed.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates training of a data mining model in accordance with the subject innovation.

FIG. 2 illustrates a methodology of updating a data mining model in accordance with an aspect.

FIG. 3 illustrates a model update system that further employs an event detection component for detecting an update triggering event in accordance with another aspect.

FIG. 4 illustrates a methodology of updating the data model based on a sliding window of time series data in accordance with another aspect of the innovation.

FIG. 5 illustrates a methodology of realtime updating the data model based on scheduling information in accordance with an aspect.

FIG. 6 illustrates a methodology of scheduling model updates during an off-peak time.

FIG. 7 illustrates a methodology of incrementally training a data model based on triggering events.

FIG. 8 illustrates a model training update system that further employs a model versioning component for update processing based on version information.

FIG. 9 illustrates a flow diagram of a methodology of utilizing model versioning in accordance with an innovative aspect.

FIG. 10 illustrates a system that employs a machine learning and reasoning component which facilitates automating one or more features in accordance with the subject innovation.

FIG. 11 illustrates a flow diagram of a methodology of processing training data according to its age.

FIG. 12 illustrates a block diagram of a computer operable to execute the disclosed data mining update architecture.

FIG. 13 illustrates a schematic block diagram of an exemplary data mining update computing environment.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

The disclosed innovation allows data mining systems to automatically maintain up-to-date mining models in realtime with respect to evolving source and/or training data. A typical scenario is where the model is based on a moving window of data that includes the last three months of purchases, for example.

Additionally, scenarios are described wherein models do not need to be updated in a realtime fashion, such as for periodic, incremental updates scheduled for off-peak processing, for example. The system is suitably robust to provide for user-configuration of a refresh interval, for example, and other associated values/parameters via training parameters for the mining structure and/or model. Training can also be triggered by other user-defined events such as database notifications, or alerts from other operational systems.

Once the mining structure and its contained models are initially processed, they are automatically reprocessed by the data mining engine according to triggering events, predetermined criteria, and/or learned data, for example. These and other aspects are described in greater detail infra.

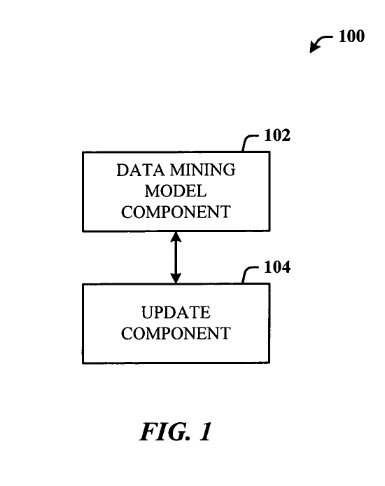

Referring initially to the drawings, FIG. 1 illustrates a computer-implemented system 100 that facilitates training of a data mining model in accordance with the subject innovation. The system 100 can include a data mining model component 102 for developing and/or training a data mining model on a dataset. The system 100 can also include an update component 104 for updating the data mining model (or models) in realtime according to predetermined criteria. The predetermined criteria can be based on scheduling data, version data, the amount of data being processed, the type and/or importance of the data being processed, and so on.

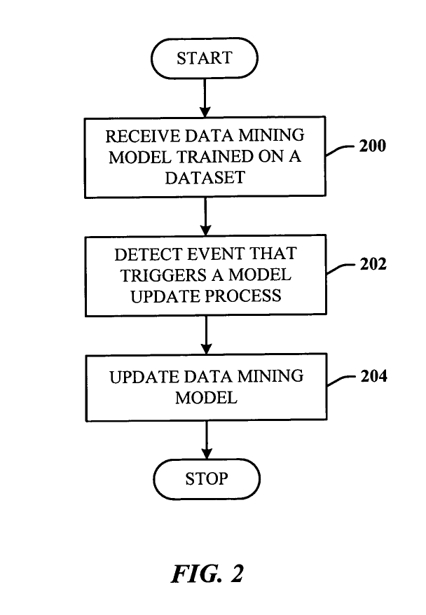

FIG. 2 illustrates a methodology of updating a data mining model in accordance with an aspect. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, a data mining model is developed and trained on a dataset. At 202, an event is detected which triggers an automatic (and realtime) update process for updating the existing model. At 204, the model is updated.

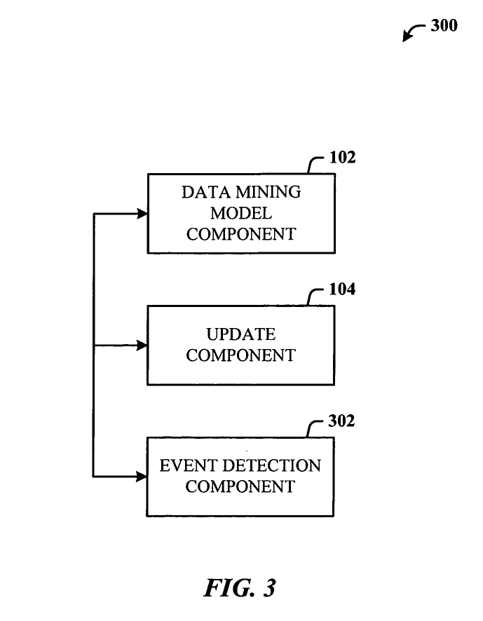

FIG. 3 illustrates a model update system 300 that further employs an event detection component 302 for detecting an update triggering event in accordance with another aspect. As before, the system 300 includes the model component 102 for developing and initial training of a data mining model, and the update component 104 for update processing of the model. The event detection component 302 can detect predetermined events such as scheduled times for updating, realtime updating when the model is being used, periodic, incremental update events, and version check events, for example.

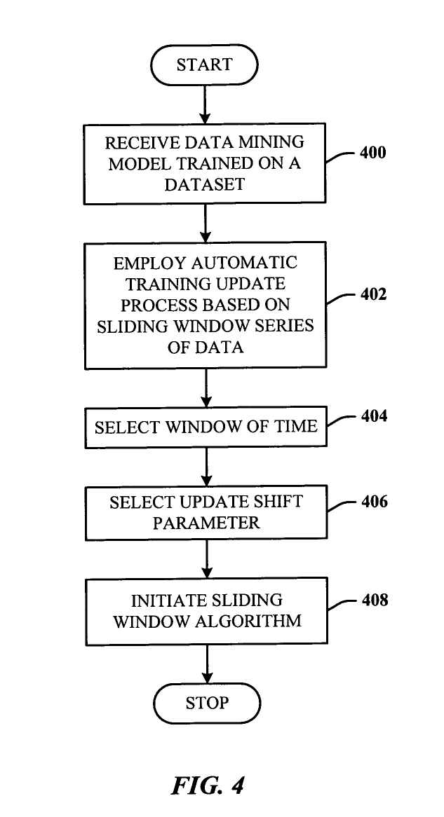

FIG. 4 illustrates a methodology of updating the data model based on a sliding window of time series data in accordance with another aspect of the innovation. At 400, a model is received that has been initially trained on a dataset. At 402, an automatic update process is employed based on a sliding window series of data. At 404, a window of time is selected. For example, the window of time can be three months in duration, or virtually any time duration desired by the user. Where changes in the data are more active, the window can be reduced to a few weeks, if desired. The window can be adjusted further based on additional criteria such as how often the data changes or how much the data changes over a given time period. Other criteria can also be employed based on the discretion and application of the data mining structure.

At 406, the user can select an update shift (or stepping) parameter that defines how often the window should be moved (or stepped) forward. For example, if the user chooses a 3-month sliding window, the shift parameter can be set to one month, that is, the window will be slid in 1-month increments every one month. At 408, once the settings are made, the sliding window algorithm can be initiated to facilitate the update process. As can be seen, the sliding window update process implements model updating on a regular basis regardless of whether the model needs updating at all. This will be addressed in a more efficient manner below.

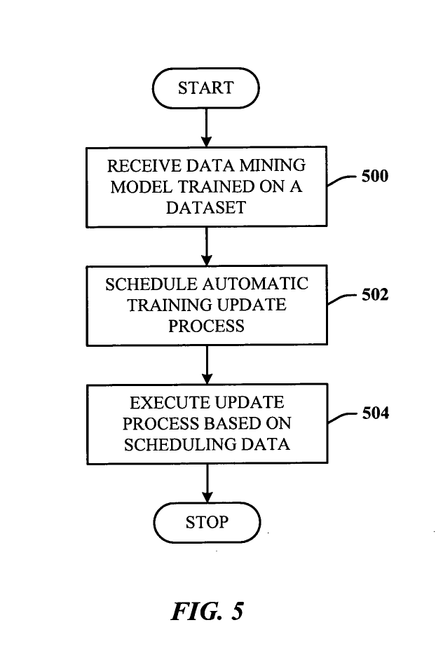

FIG. 5 illustrates a methodology of realtime updating the data model based on scheduling information in accordance with an aspect. At 500, a trained model is received. At 502, an update process is scheduled for automatic execution. At 504, when the scheduled time arrives, the update process is automatically executed to update the model.

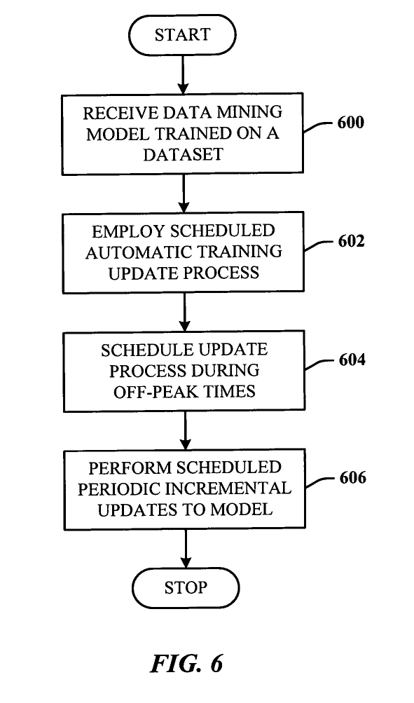

Referring now to FIG. 6, there is illustrated a methodology of scheduling model updates during an off-peak time. At 600, a trained data mining model is received. At 602, scheduled automatic update training is employed. At 604, one or more off-peak times are scheduled for update of the model. When the appointed off-peak time arrives, the update process automatically executes to update the model. It is to be understood that more than one off-peak time can be scheduled. That is, a primary off-peak time can be scheduled for a first attempt at updating, followed by a later (or secondary) off-peak time, in case the first time is missed or fails to execute for some reason, such as a system fault, network fault, etc.

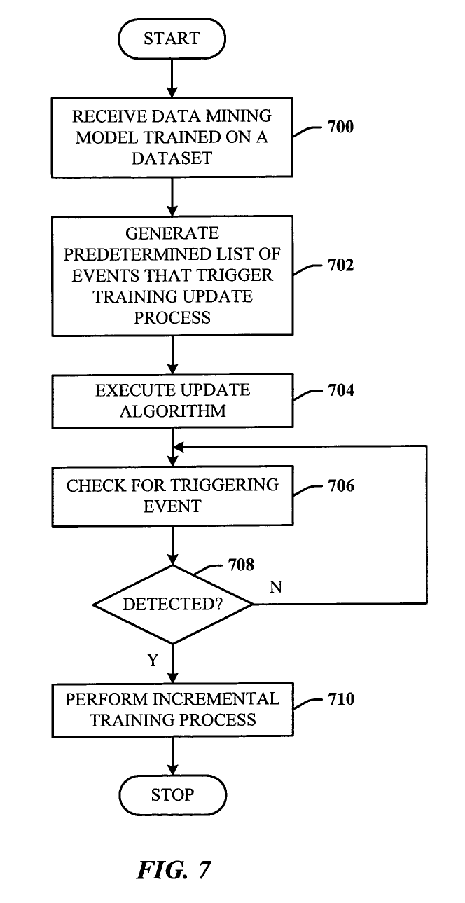

FIG. 7 illustrates a methodology of incrementally training a data model based on triggering events. At 700, a trained data mining model is received. At 702, a list of predetermined events is generated, the presence of which will trigger a training update process. At 704, an update algorithm is executed. At 706, the system checks for a triggering event based on the supplied list of triggering events. At 708, if no event is detected, flow progresses back to 706 to continue checking for a triggering event. On the other hand, at 708, if a triggering event is detected, flow is to 710 to perform the incremental training process to the existing mining model.

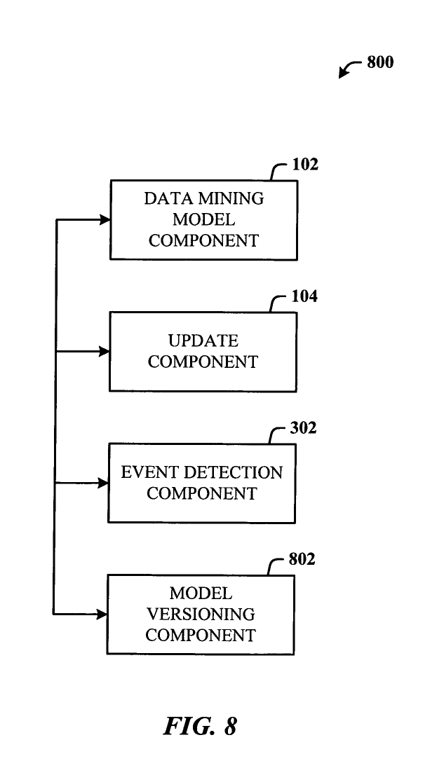

FIG. 8 illustrates a model training update system 800 that further employs a model versioning component 802 for update processing based on version information. The system 800 includes the data mining component 102, the update component 104, and the event detection component 302. It is to be understood that as the data mining model changes due to training updates, each changed model can be assigned or tagged with version data. Thereafter, further processing can be performed on the versioned models to, for example, determine the degree of change from one model version to the next or to another. By analyzing model version for changes, it can be determined if a training update is or was warranted. For example, if the change is sufficiently small, it can be reasoned that the time between training processes can be extended to save on performance and overhead processing issues. Similarly, if by analyzing the differences between the trained model versions it can be found that the change is substantial, it can further be deduced that the training process should be performed more frequently to provide a more accurate model for use. In another use thereof, if for some reason one model version is destroyed or corrupted, a stored model version that existed close in time or version can be inserted for execution until a more up-to-date version has been created. These are just some of the benefits of versioning.

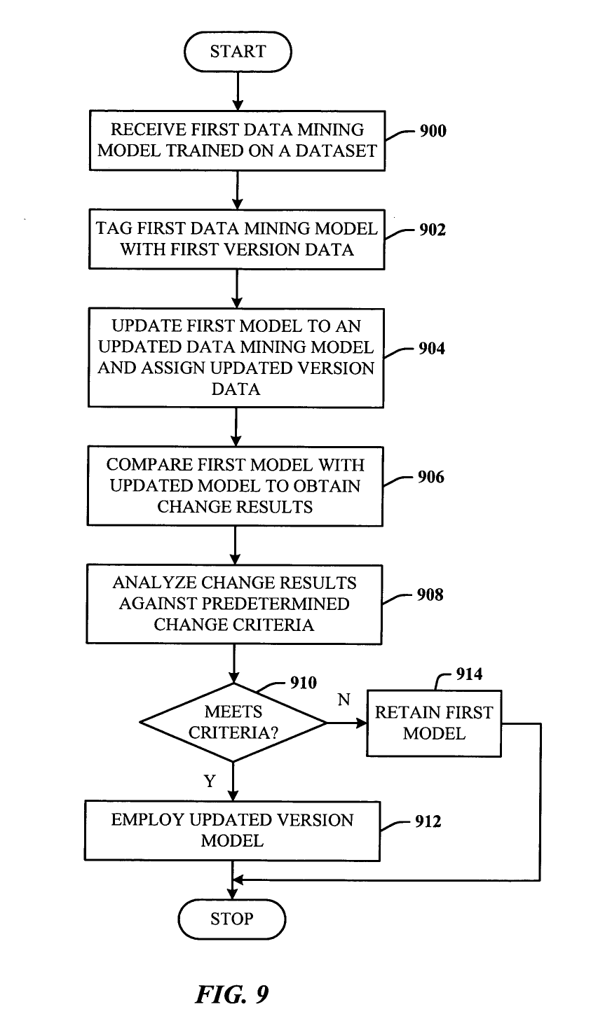

FIG. 9 illustrates a flow diagram of a methodology of utilizing model versioning in accordance with an innovative aspect. At 900, a first data mining model is received and trained on a dataset. At 902, the first trained model is tagged with version data. The version data can be a number and/or timestamp information, for example. At 904, the first rained model is updated to become a second version model having second version data associated therewith. At 906, the first and second models are compared to obtain results. At 908, the results are analyzed against predetermined change criteria. At 910, if the change meets the criteria, flow is to 912 to employ the second model. Alternatively, if the results do not meet the criteria, the first model is retained. This process can continue. That is, the next update model version can be compared against the model retained for processing. In another implementation, the comparison can be made only against sequential versions of models. In other words, the first version is compared to the second version, the second version against the third version, and so on.

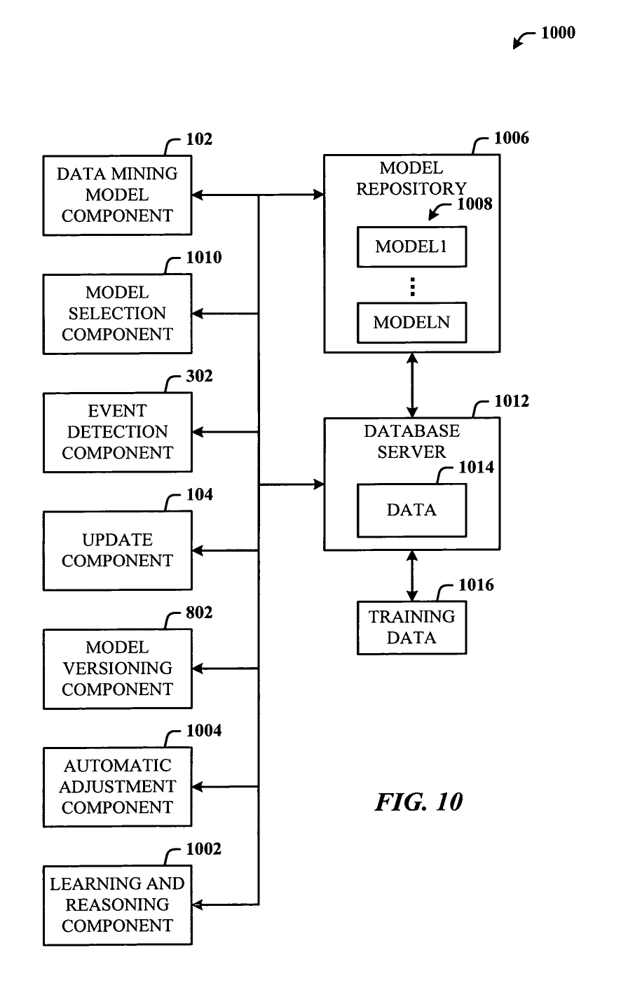

FIG. 10 illustrates a system 1000 that employs a machine learning and reasoning component 1002 which facilitates automating one or more features in accordance with the subject innovation. In this particular implementation, the system 100 includes the model component 102, update component 104, and event detection component 302, and model versioning component 802, as described above. In addition to the learning and reasoning component 1002, an automatic adjustment component 1004 can also be included for automatic adjustment of one or more parameters and functions, which will be described. The system 1000 can also include a model repository 1006 that receives and stores one or more data mining models 1008 (denoted MODEL1, . . . , MODELN). These repository models 1008 can include outdated models, new training models, as well as updated and versioned models, for example.

In support managing and storing many different models 1008, the system 1000 can further include a model selection component 1010 that facilitates the selection of one or more of the models 1008 for analysis, processing, versioning, and updating, for example.

The system 1000 can also include a database server system 1012 which interfaces to the model repository 1006 to provide data 1014 against which the one or models 1008 can be processed, and through which can be accessed training data 1016.

The event detection component 302 can also process alerts and/or notifications from other systems as triggers to perform various functions. For example, an alert from a remote system (e.g., the database server 1012) can indicate that sufficient amounts of new data have arrived in the data 1014 that warrant a model training update process to be performed. In another example, a remote system (not shown) is configured to transmit notifications that are processed as trigger events for performing one or more system functions (e.g., age out data, weighting data, . . . ).

The automatic adjustment component 1004 can be employed to make adjustments to system parameters based on, for example, the changing state of the underlying datasets, the training data, the accuracy of the existing model on data, and so on. Accordingly, algorithms can be designed and implemented that monitor functions and results of the system 1000, and based on predetermined adjustment criteria, alter settings, parameters, etc., accordingly to provide the desired outputs.

The learning and reasoning (LR) component 1002 can learn system behaviors and reason about what changes to be made. The subject invention (e.g., in connection with selection) can employ various LR-based schemes for carrying out various aspects thereof. For example, a process for determining when to perform a training model update can be facilitated via an automatic classifier system and process. Moreover, where the database server 1012 has data that is, for example, distributed over several locations, the classifier can be employed to determine which location will be selected for model processing.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or other statistical analysis (e.g., one factoring into the analysis utilities and costs to maximize the expected value to one or more people) to prognose or infer an action that a user desires to be automatically performed. In the case of data systems, for example, attributes can be words or phrases, or other data-specific attributes derived from the words (e.g., database tables, the presence of key terms), and the classes are categories or areas of interest (e.g., levels of priorities).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of ranking or priority.

As will be readily appreciated from the subject specification, the subject invention can employ classifiers that are explicitly trained (e.g., via a generic training data) as well as implicitly trained (e.g., via observing user behavior, receiving extrinsic information). For example, SVM's are configured via a learning or training phase within a classifier constructor and feature selection module. Thus, the classifier(s) can be employed to automatically learn and perform a number of functions according to predetermined criteria.

In one example, the LR component 1002 can monitor mining results associated with a sliding window with respect to the quality of the mining model being generated therefrom and/or the amount of change computed between models. For example, consider a trained mining model that is applied against data extracted in a 5-month wide sliding window, which is being moved every two weeks. Based on a qualitative description parameter that is a measure of how well the model describes the data, or a prediction parameter that provides some measure of how well the trained model predicts data patterns or behavior, the LR component learn and reason to make adjustments to sliding window parameters accordingly. For example, if the description measure falls below a predetermined level, the LR component can control the automatic adjustment component 1004 to reduce the window width to four months in an attempt to improve the measure. Once the measure improves, the LR component 1002 can signal the adjustment component 1004 to continue at the present settings or even to relax back to the 5-month wide window.

Similarly, the LR component can learn and reason to adjust the stepping time from two weeks to another value, for example, three weeks, based on descriptive and/or predictive qualities.

In another example, the LR component 1002 can perform basic analysis on the data or be made aware of the type of data being modeled, which type information can change the behavior in operation of the system 1000. For example, if the data is medical information being analyzed for medical information, the degree of accuracy required can be much higher than if based on customer shopping behavior or patterns. The LR component 1002 can detect his and make adjustments through the automatic adjustment component 1004 accordingly.

In yet another example, the LR component 1002 can learn that a first model performs better over another model even though the underperforming model is a most recently trained version. Accordingly, the first model can be retained until a better model has been created tested and trained for implementation.

The LR component can learn and reason that the training data 1016 employed can be negatively affecting the quality of the models being used, and thus, cause a new set of training data to be generated, tested, and employed for model training.

In yet another example, the LR component 1002 can learn and reason that system notifications and/or alerts are normally associated with certain types or versions of models, which can then be automatically implemented based on the next received alert or notification.

As indicated by example, the potential benefits obtained by the LR component 1002 are numerous, and the examples presented herein are not to be construed as limiting in any way. For example, other implementations can employ the LR component 1002 to facilitate processing of aging data, for example, such that aged data is treated differently that more recent data.

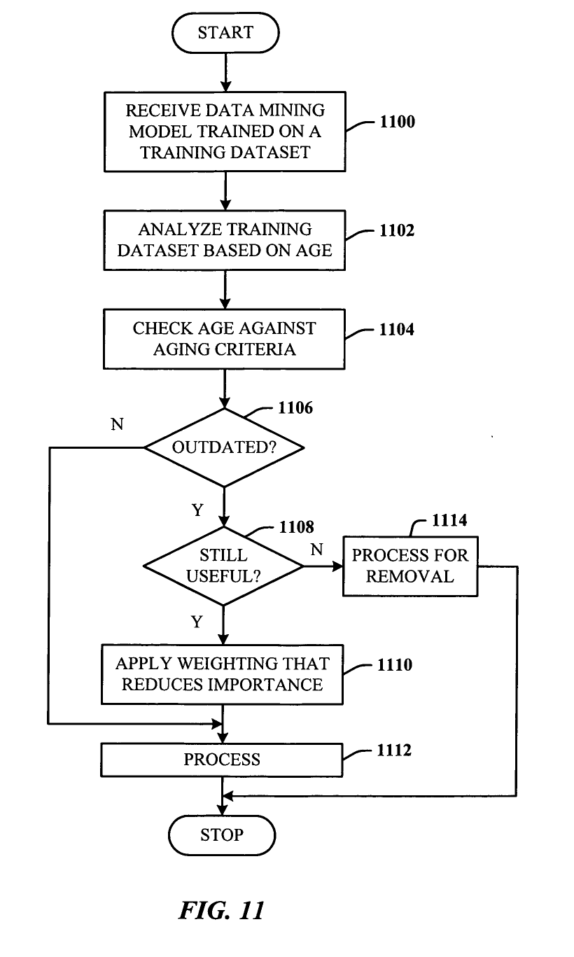

FIG. 11 illustrates a flow diagram of a methodology of processing training data according to its age. At 1100, a trained data mining model is received after training on a training dataset. At 1102, the system analyzes the dataset based on it age. At 1104, the system checks data age against age criteria. At 1106, if the data is outdated (the age is outside predetermined criteria), the system can then downplay its usefulness in model processing or discard the data altogether. Accordingly, at 1108, the system further checks if the data is still useful. If so, at 1110, the system can associate weighting information to the data such that the data can still be used, but given less importance that other data during a learning process. At 1112, the system then processes the aged weighted data and other data. If, on the other hand, at 1106, the data is not outdated, flow is to 1112 to continue processing normally. Additionally, if the data is no longer useful, at 1108, flow can be to 1114 to process the data for removal. This can include archiving a record of the data and/or discarding the data.

The subject invention finds application to data mining extensions (DMX) and data definition language (DDL) enhancements to allow specification of the parameters for automatic processing. DMX is a query language for data mining models, much like SQL (structured query language) is a query language for relational databases and MDX is a query language for OLAP databases. DMX is composed of DDL statements, data manipulation language (DML) statements, and functions and operators. The DDL part of DMX includes DDL statements which can be used to create, process, delete, copy, browse, and predict against data mining models, for example, create new data mining models and mining structures (via CREATE MINING STRUCTURE, CREATE MINING MODEL), delete existing data mining models and mining structures (via DROP MINING STRUCTURE, DROP MINING MODEL), export and import mining structures (via EXPORT, IMPORT), and copy data from one mining model to another (using SELECT INTO). Additionally, DDL statements are used to create and define new mining structures and models, to import and export mining models and mining structures, and to drop existing models from a database.

DML statements can be used to train mining models (via INSERT INTO), browse data in mining models (using SELECT FROM), and make predictions using mining models (via SELECT . . . FROM PREDICTION JOIN).

Accordingly, the user can specify automatic model training information using a mining model definition language, in both XML (extensible markup language) DDL (data definition language) (analysis service scripting language) and query language enhancements in the DMX language (Data Mining eXtensions to the SQL language).

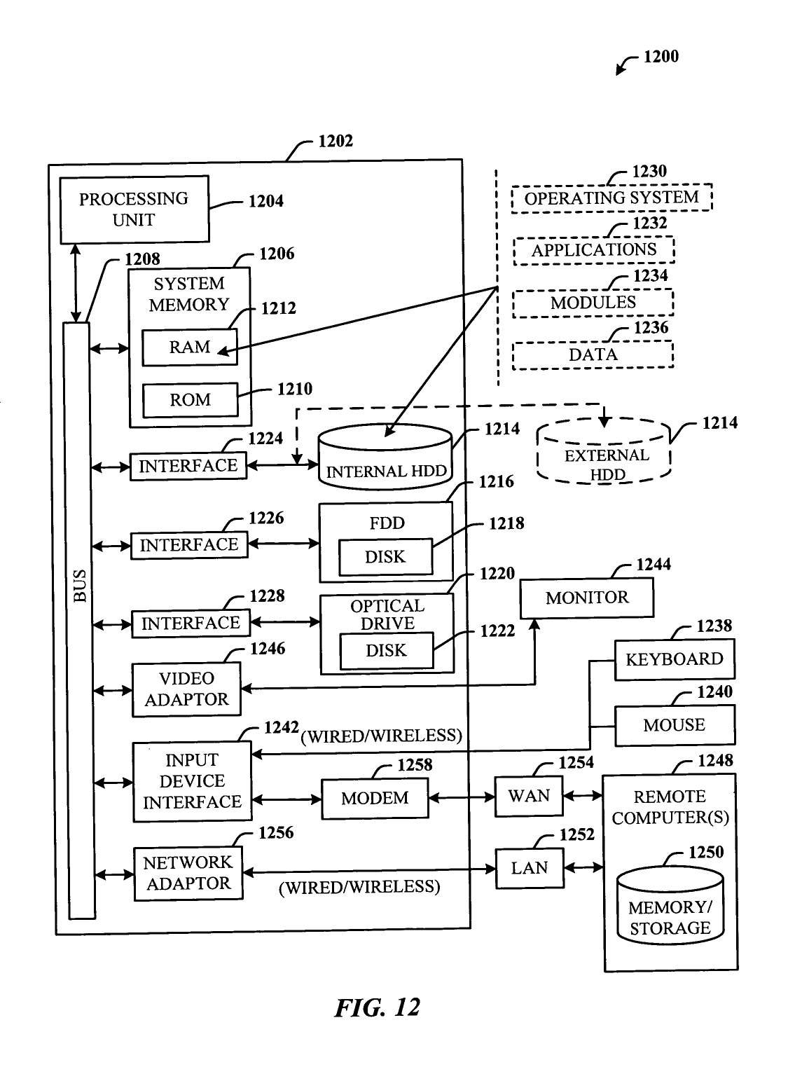

Referring now to FIG. 12, there is illustrated a block diagram of a computer operable to execute the disclosed data mining update architecture. In order to provide additional context for various aspects thereof, FIG. 12 and the following discussion are intended to provide a brief, general description of a suitable computing environment 1200 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 12, the exemplary environment 1200 for implementing various aspects includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adaptor 1256 may facilitate wired or wireless communication to the LAN 1252, which may also include a wireless access point disposed thereon for communicating with the wireless adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

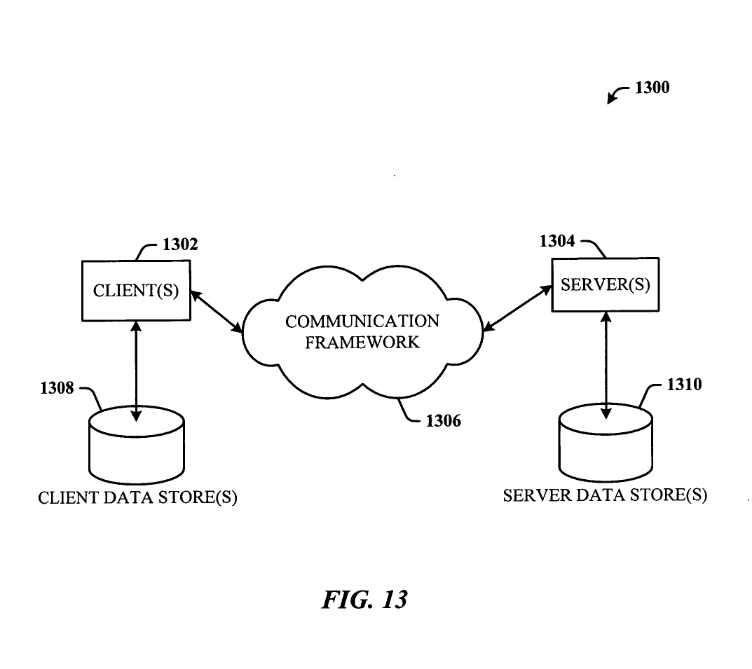

Referring now to FIG. 13, there is illustrated a schematic block diagram of an exemplary data mining update computing environment 1300 in accordance with another aspect. The system 1300 includes one or more client(s) 1302. The client(s) 1302 can be hardware and/or software (e.g., threads, processes, computing devices). The client(s) 1302 can house cookie(s) and/or associated contextual information by employing the subject innovation, for example.

The system 1300 also includes one or more server(s) 1304. The server(s) 1304 can also be hardware and/or software (e.g., threads, processes, computing devices). The servers 1304 can house threads to perform transformations by employing the invention, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates training of a data mining model, comprising:
a data mining model component for training a data mining model on a dataset; and
an update component for updating the data mining model according to predetermined criteria.

2. The system of claim 1, wherein the update component updates the data mining model in realtime based on the predetermined criteria.

3. The system of claim 1, wherein the update component updates the data mining model according to a periodic interval.

4. The system of claim 1, wherein the update component updates the data mining model according to event-triggered criteria.

5. The system of claim 1, wherein the update component updates the data mining model incrementally according to a scheduled update process.

6. The system of claim 1, wherein the update component updates the data mining model in response to detecting changes in the underlying data that exceed the predetermined criteria.

7. The system of claim 1, wherein the update component updates the data mining model based on version information of the model.

8. The system of claim 1, further comprising a machine learning and reasoning component that employs a probabilistic and/or statistical-based analysis to prognose or infer an action that a user desires to be automatically performed.

9. The system of claim 1, further comprising an event detection component that initiates updating of the data mining model based on receipt of at least one of a notification and an alert.

10. The system of claim 1, further comprising an automatic adjustment component that automatically changes an update parameter based on a change in the dataset.

11. The system of claim 10, wherein the automatic adjustment component facilitates selection of the data mining model from a plurality of data mining models.

12. A computer-implemented method of updating a data mining model, comprising:
receiving a data mining model;
training the data mining model on a set of training data;
applying the data mining model to a set of data;
detecting change data; and
automatically updating the data mining model to an updated mining model in response to detecting the change data.

13. The method of claim 12, wherein the act of updating occurs in realtime.

14. The method of claim 12, further comprising an act of comparing the data mining model to a previous data mining model to obtain compare results, and performing the act of updating in response to the compare results.

15. The method of claim 12, further comprising an act of reducing importance of the set of training data by weighting some or all of the training data differently than other training data.

16. The method of claim 12, further comprising an act of specifying training information

17. The method of claim 12, further comprising an act of assigning version data to the data mining model and the updated mining model, and analyzing the version data to determine when to perform the act of training.

18. The method of claim 12, further comprising an act of retaining the updated mining model only when the update model meets predetermined threshold criterion.

19. The method of claim 12, further comprising an act of automatically changing parameters of a sliding data window based on learned and reasoned information.

20. A computer-implemented system for updating a data mining model, comprising:
computer-implemented means for training a data mining model on a set of training data;
computer-implemented means for applying the data mining model to a set of data;
computer-implemented means for receiving change data that indicates a change; and
computer-implemented means for automatically incrementally updating the data mining model to an updated mining model in response to receiving the change data.
